(19) United States
(12) Patent Application Publication
(10) Pub. No.: US 2002/0133576 A1
(43) Pub. Date: Sep. 19, 2002

(54) System with a server for verifying new components

(76) Inventors: Ronald Leo Christiaan Koymans, Eindhoven (NL); Rob Theodorus Udink, Eindhoven (NL)

Correspondence Address: U.S. Philips Corporation, 580 White Plains Road, Tarrytown, NY, 10591, US

(21) Appl. No.: 10/087,974

(22) Filed: Mar. 4, 2002

(30) Foreign Application Priority Data
Mar. 9, 2001 (EP) 01200892.6

(51) Int. Cl. G06F 15/177; G06F 9/44; G06F 9/445

(52) U.S. Cl. 709/221; 717/171; 717/176

(57) ABSTRACT

When a new system component is loaded into a system, the system sends information about the system component and a configuration of the system to a remote acceptance server. The acceptance server verifies whether the system including the system component and configured according to information about the configuration meets a criterion of interoperability, for example by checking that it does not contain illegal instructions which damage critical system data or functions that are not available in the configuration. The server sends an acceptance signal to the system. The acceptance signal may detail which of multiple events handled by the computer program are handled acceptably. The system qualifies operation of the system component dependent on the acceptance signal, for example by disabling operation of the new system component or handling of events that are not handled acceptably according to the acceptance signal.

The invention relates to a system that contains a computer, to components of this system and to methods of operating the system and its components. The invention relates in particular to verification whether components, particularly programs can be safely operated as part of the system.

An article titled “Managing System and Active Content Integrity” by John. R. Michener and Tolga Acar, published in Computer Vol. 33 No. 7 pages 108-110, July 2000 addresses the problem of system integrity, i.e. the protection of computer systems against misuse or system damage due to incorporation of malfunctioning software components into the system. The article addresses system integrity of computer systems by ensuring that only programs (modules in the terminology of the article) of trusted origin are allowed to execute on the computer system. The trusted origin is assumed to be a guarantee that such programs will not intentionally attempt to misuse or even damage system resources. Also, execution of old versions of programs of any origin should be avoided to prevent known bugs, which have been repaired in newer versions.

The article by Michener et al. describes the use of a strong loader and an integrity server. The strong loader is needed to load programs into the system before they can be executed. Before loading, the strong loader obtains a configuration management file from the integrity server. The configuration management file contains a list of loadable programs. It specifies acceptable version numbers of these programs and information that allows a check whether the program has not been tampered with. The strong loader will load the program only if it corresponds to the information specified in the configuration management file.

The technique described by Michener et al. assumes a relatively closed system: the integrity server has to know all allowable programs before they can be loaded into the computer system. Unknown programs will not be accepted and only the latest version, or a range of most recent versions, of a program is accepted. Programs can be executed only after the configuration management file has been received from the integrity server.

This is disadvantageous in very open systems, such as home networks, in which a generally unskilled consumer should be able to integrate apparatuses and software (which will be commonly referred to as components of the system) from various manufacturers, both the components and the manufacturers being a priori unknown.

In a home network system, such as a HAVi system for example, the system typically contains software, like games, and apparatuses like a set-top box, a television, a video recorder etc. connected via a communication network. Operation of a first apparatus may involve executing a program on a second apparatus, for example controlling operation of the first apparatus from the second apparatus to avoid the expense of a computer or a user interface device in the first apparatus.

In general, such a system will be a mixture of older and newer components from various manufacturers. Different consumers will have different configurations, in which a component with the same overall function, say a set-top box, has different capabilities from one system to another, depending on the manufacturer and the version of the component.

It is desirable that the integrity of such a system is protected as much as possible, without requiring the consumer to upgrade his or her entire system from a single manufacturer each time a new component is added. It is a valuable service to consumers to warn and/or protect them against potential malfunctions and it is also valuable for manufacturers that their products give clear warnings about potential malfunctions rather than merely crashing for some unspecified reason, provoking dissatisfaction from consumers with an innocent manufacturer.

However, the integrity protection described in the article by Michener et al. is not very suitable to such open consumer systems. In the first place this integrity protection assumes that the integrity of the system can be guaranteed simply by identifying a set of programs that may be loaded into the system. This does not reflect the situation in a very open system, where a program may be perfectly functional in one configuration of the system, say with apparatuses from the manufacturer of the computer program, whereas the same program is not functional in another configuration. One cannot assume that the consumer always has recent versions of all components.

In the second place, the integrity protection of Michener does not help the consumer to locate and solve the integrity problem. In fact, after adding a new component, that requires a new computer program to be executed in a pre-existing apparatus it may appear to the consumer that the pre-existing apparatus malfunctions, whereas the problem is really one of the new computer program introduced by the new component. Obviously, this is an undesirable situation for the manufacturer of the pre-existing situation, who will lose consumer goodwill through no fault of his own.

In the third place, the integrity protection of Michener et al. has the effect of excluding software from new manufacturers, which may be perfectly functional, if the new manufacturer is not certified as a trusted source. This unnecessarily restricts the choice of the consumer.

In the fourth place, the integrity protection of Michener et al. requires a strong loader, which may increase the cost of the system without adding visible functionality to the consumer.

It is an object of the invention to provide a more flexible inspection of the acceptability of a computer program for execution in a system with a computer.

The invention provides for method of protecting the integrity of a computer system, the method comprising

loading a new system component into a system with a computer;

in response to said loading, sending information about said system component and a configuration of the system with a to an acceptance server via a remote communication network;

verifying with said acceptance server whether the system with a computer including the system component and configured according to information about the configuration meets a criterion of interoperability;

sending an acceptance signal from the acceptance server to the system with a computer via the remote communication network;

qualifying operation of the system with a computer including the system component dependent on the acceptance signal.

According to the invention the system makes use of a remote acceptance server. When a new component is introduced into the system, the system sends a message to the acceptance server, which responds with an acceptance signal that signals whether problems are to be expected when the component is integrated into the system.

The message informs the acceptance server about the new component and the configuration of the system, for example about the type and/or manufacturer of the apparatus on which a new computer program has to be executed. The acceptance server then determines whether the new component will operate acceptably in the identified configuration, that is, it will not check merely, if at all, whether the latest version of the new component has been loaded. For example, the acceptance server may check whether the specified apparatus of the specified manufacturer is able to run the new computer program and will not be corrupted by the computer program. The result of this check may be different from a corresponding result for generally similar, but not identical apparatuses from other manufacturers. In fact it may turn out that an outdated version of the computer program runs perfectly well in the system, or that the latest version of the computer program does not run acceptably, for example because other system component are not adapted to the latest version.

The system then qualifies its operation according to the acceptance signal received from the acceptance server. In a first embodiment, qualification involves disabling the new component if it is signaled that it is unacceptable. In another embodiment the system merely warns the user that the component entails the risk of non-interoperability. In yet another embodiment, the acceptance signal identifies which of a plurality of functions performed by the new component are not interoperable and disables, or warns about, only those identified functions. Qualification need not be immediate: in an embodiment the system may start incorporating and executing the new component even before the acceptance signal has been received only to qualify its operation after reception of the acceptance signal. This is particularly the case if only non-interoperability of some of the functions of the new component may be feared, without actual damage. In general it is to be expected that the main functions of the new component operate properly, non-interoperability occurring only for the less frequently executed (and therefore less thoroughly tested) functions. Operation may be started before reception of the acceptance signal in the expectation that the user will activate the not-interoperable functions only later, probably after the acceptance signal has been received (this is not an insurmoutable problem when reduction of the number of system malfunction rather than system security is the issue).

The invention may be applied in particular to the case where an new apparatus is added to a network system, like a HAVi system, and then uploads a control program to an existing apparatus in the system for control of the new apparatus. Ordinarily, one would expect this control program to be adequate for the new apparatus, since it is uploaded at the instigation and for the control of the new apparatus itself. However, it may turn out that the control program is not, or only partly, operable on the existing apparatus, for example because this existing apparatus is of an older type or from an unexpected manufacturer. In this case the invention allows the system to disable the new apparatus, or such of its functions that are not-interoperable, without crashing.

The acceptance signal may be formed by reference to a list of combinations of configurations and new components, but in case of unknown combinations, the acceptance server may actually simulate operation of the component in the specified configuration to identify non-interoperability problems. Because such a simulation will have to be performed relatively infrequently, it is preferably relegated to a server that is available for many consumer systems. Such a server can add a valuable customer support function if this server is made available for apparatuses from one manufacturer, to be contacted (e.g. via the internet) by an apparatus from the manufacturer each time the apparatus encounters a new computer program that has to be executed by the apparatus. Alternatively, such a server can be run as an independent service available for example to subscribers with apparatuses from various manufacturers.

These and other advantageous aspects of the system, methods and apparatus according to the invention will be described in more detail using the following figures.

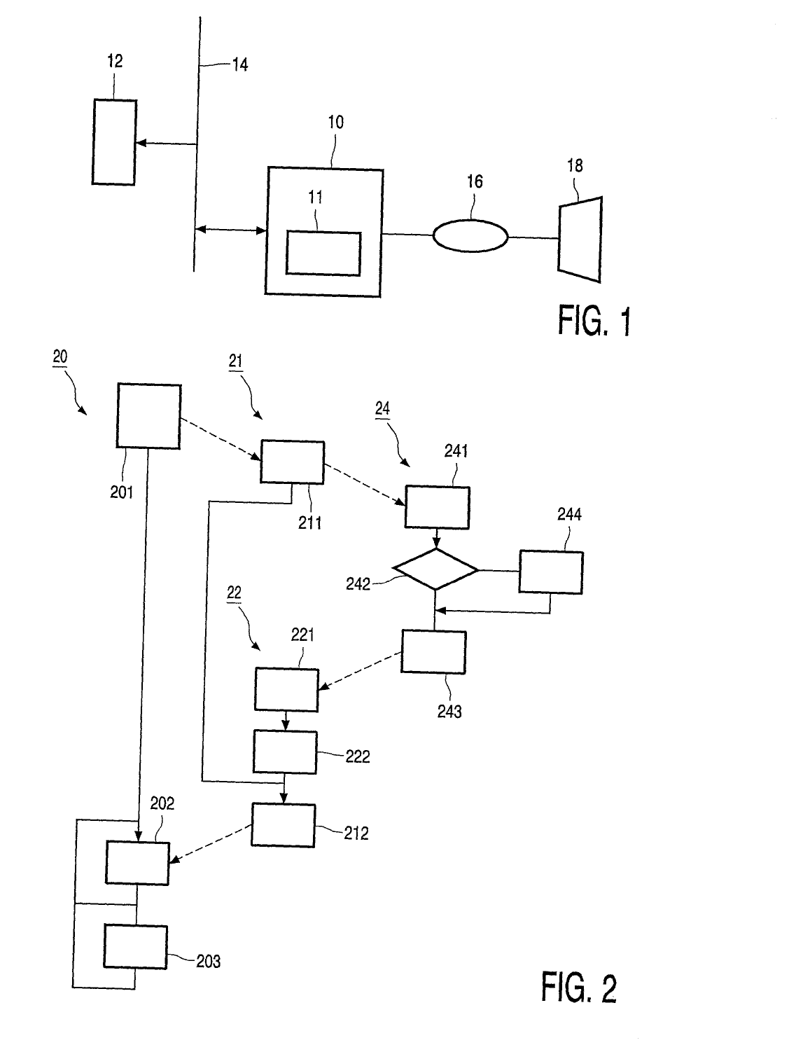

FIG. 1 shows system with a computer

FIG. 2 shows a flow-chart of operation of the system

FIG. 1 shows a system with a first apparatus 10, that contains a computer 11, a second apparatus 12 a local communication bus 14, a remote communication network 16 (preferably the Internet) and a server 18. The first apparatus 10 and the second apparatus 12 are connected to each other via bus 14. The first apparatus is connected to the server 18 via the remote communication network 16. Although a system with a single bus 14 is shown by way of example, it will appreciated that the invention can be applied to communication network structures in general.

In operation, the first apparatus 10 uses computer 11 to execute computer programs, for example Java byte codes. One or more of the programs may be control programs for controlling the second apparatus 12 via the communication bus 14. Execution of such a program involves for example generating and showing a user interface image in first apparatus 10, receiving user commands with first apparatus 10, translating the commands into control messages and sending the control messages to second apparatus 12. Execution of this program may also involve receiving messages from second apparatus 12, processing these messages and in response displaying information to the user, controlling other apparatuses (not shown) on the communication bus 14 and/or returning control messages to second apparatus 12.

First apparatus 10 is for example a set-top box with a powerful computer 11, such as a MIPS processor, with a large operating memory. Second apparatus 12 is for example a video recorder or a simple household appliance, such as a coffee machine, which does not contain such a powerful processor or such a large memory or user interface facilities. A third apparatus (not shown) may be a display screen connected to the communication bus 14, controlled by the set-top box and used to display a user interface to a user. A fourth apparatus (not shown) may be a remote control unit used to send user commands to the first apparatus 10.

The control program for controlling second apparatus 12 may be uploaded from second apparatus 12 into first apparatus 10. In this way, the cost of second apparatus 12 can be kept low, since no powerful computer or user interface hardware need be included. The control program is for example a Java Byte code program. First apparatus 10 can be used to control second apparatus even though first apparatus 10 is designed, manufactured and sold without knowledge of second apparatus 12. This saves overhead costs in first apparatus 10 and allows it to be manufactured even before the controlled second apparatus 10 has been designed or manufactured.

The control program may be divided into different event handlers, for example for handling different commands received from the (human) user of the apparatus. For example, the control program may have an event handler for a “start recording” command and for a “play-back” command etc.

FIG. 2 shows a flow-chart of the operation of the system in case of an upload. The flow-chart shows four threads of control flow: a first thread of control 20 in the second apparatus 12, a second and third thread of control 21, 22 in the first apparatus 10 and a fourth thread of control 24 in the server 18.

When the second apparatus 12 is connected to the system (for example by physical connection to the bus 14 or by switching on its power), the first thread 20 is activated. In the first thread 20 second apparatus 12 executes a first step 201 to upload a control program from second apparatus 12 to first apparatus 10. (Alternatively, second apparatus 12 may send a reference to first apparatus 10 to where first apparatus can fetch the control program, for example an internet ftp address of a file that contains the control program). Subsequently, second apparatus 12 starts a second step 202 in which it waits for command messages received via the bus 14. If such a message is received second apparatus 12 executes a third step 203 and waits for a next command by repeating from the second step 202.

The upload initiated by the first step 201 triggers execution of a second thread 21 in first apparatus 10. First apparatus 10 executes a fourth step 211, opening a connection to the remote communication network 16 (e.g. the Internet) and sending information about itself and the uploaded control program to the server 18. Subsequently, in the embodiment shown in FIG. 2, the first apparatus 10 executes a fifth step 212 in which it transfers control to the uploaded program. The address to which the first apparatus 10 directs this sending is preprogrammed in the first apparatus, for example to an Internet address provided by the manufacturer of the first apparatus 10. Alternatively, the site may be specified by the second apparatus 12 together with the uploaded program, but this has the disadvantage that the first apparatus loses control over the assurance that it will operate properly.

The information sent by the first apparatus 10 to the server 18 triggers the server 18 to execute the fourth thread 24. The fourth thread 24 starts with a seventh step 241 in which the server 18 receives the information about the first apparatus 10 and the uploaded program. In an eight step 242 the server 18 consults a list with entries for combinations of uploaded programs and apparatuses, each entry contains information about the acceptability of the combination, preferably particularized for a number of functions that is available in the program. This list is stored in server 18 on a computer readable medium (not shown). If the combination identified in the information from the first apparatus 10 is in the stored list, a ninth step 243 is executed, sending an acceptance signal back to the first apparatus 10. The acceptance signal contains information about the acceptability of the combination of the first apparatus and the uploaded program. Optionally, this information is particularized for various parts of the uploaded program which perform execution of distinct user commands. Preferably, the acceptance signal indicates starting points of execution of at least those parts that are not acceptable. The list may be generated automatically by verification of various combinations of (versions of) uploadable software and (versions of) apparatuses and their configuration. But such a list may also be compiled in advance and stored by human intervention.

If the combination is not in the stored list, the server preferably executes a tenth step 244 in which the uploaded program is verified for the first apparatus 10, in its configuration according to the information received from the first apparatus 10. Verification may involve simulating execution of all possible execution branches of the uploaded program, or responses of all possible events such as user commands that trigger execution of part of the uploaded program, to detect whether these branches or events cause execution of illegal operations or will cause the system to hang or crash. Instructions for illegal operations include for example instructions to overwrite critical system data, instructions to erase files unrelated to the second apparatus 12, instructions that call functions of the first apparatus 10 that are not available, instruction sequences that may result in damage to hardware. The criterion for the acceptability of the computer program is that it does not contain such instructions.

For this purpose it is necessary that the first apparatus 10 communicates the instructions of the uploaded program to the server 18, or at least gives a reference to where the server can fetch this program.

In case the uploaded program is arranged to respond to different events, such as different user commands, simulation may be performed for each event separately, so as to determine which of the events can be handled acceptably and which not.

Instead of simulating the program the server 18 may scan the uploaded program for instructions which may command illegal or not-interoperable operations and determines whether these instructions are reachable under conditions in which the instructions should not be executed (for example, if the uploaded program contains a function call instruction, whether the function is available in the first apparatus 10 and whether the parameters of this function call are in an admissible range for that apparatus, or when the uploaded program contains an instruction for altering essential system data such as addresses of other apparatuses connected to the bus, that such alterations are limited to those alterations for which the uploading device is enabled). The server 18 enters the result of the scan or simulation into the list and executes the ninth step 243.

Transmission of the acceptance signal from the server 18 to the first apparatus 10 triggers execution of the third thread 22. Executing the third thread 22, the first apparatus 10 receives the acceptance signal in an eleventh step 221. Subsequently, in an twelfth step 222, the first apparatus 10 disables the uploaded program, or such of its functions or event handlers that are identified as unacceptable in the acceptance signal, when the acceptance signal indicates that the uploaded program will not execute acceptably in the first apparatus 10. Disabling is performed for example by inserting an instruction that throws an exception at those points in the uploaded program that start execution of a part of the uploaded program that has been identified as unacceptable in the acceptance signal.

After processing the acceptance signal the third thread 21 continues with the sixth step 212. In the sixth step 212 control is given to the uploaded program, unless the acceptance signal has signaled that the uploaded program is entirely unacceptable. If the uploaded program is to be activated in response to a user command, the first apparatus 10 checks whether execution of that user command has been indicated as unacceptable in the acceptance signal. If so, the first apparatus 10 does not execute the user command. Preferably, the first apparatus issues a warning instead, informing the user that the uploaded software has been disabled as unacceptable.

In the embodiment shown the entire uploaded program will be executed without qualification when the first apparatus 10 executes the uploaded program in the second thread 21, i.e. before the first apparatus 10 has received the acceptance signal back from the server 18. This is intended for the situation where the unacceptability is only a matter of inconvenience to the user, such as a lack of response, a hanging system or a system crash that can be overcome at the expense of additional user action and not a matter of danger to vital interests. Thus, once the acceptance signal has been received from the server 18, the user will be protected against inconvenience, but up to that time there is the risk that some inconvenience occurs if the user activates an unacceptable function.

In an alternative embodiment, the first apparatus 10 disables the uploaded software until it receives an acceptance signal. Thus the user is more fully protected against unacceptable functions, but at the expense of a period in which the uploaded program is not available.

Various alternative embodiments exist for handling unacceptable uploaded programs or execution threads in such programs:

disabling (as described above) the unacceptable parts of the uploaded program

warning before execution of the unacceptable parts

disabling unacceptable parts with serious effects and warning about unacceptable parts with less serious effects

replacing execution of unacceptable parts with execution of alternative instructions provided by the first apparatus 10 or the server 18.

In an alternative embodiment the unacceptable functions are not disabled upon reception of the acceptance signal, but a warning signal is added that enables the user to discontinue execution of a command upon receiving a warning that it involves execution of unacceptable instructions. In a further embodiment the warning signal and disabling are combined. In this embodiment, the server distinguishes between parts of the uploaded program that should be disabled and parts that should be warned about (for example parts that cause irreversible damage and parts that merely cause inconvenience respectively).

Often, parts of the uploaded program may perform functions for which alternatives exists (for example, using of display instead of a printer to output information). In this case, if such a function in the uploaded program is indicated to be unacceptable in the acceptance signal, the acceptance signal preferably also indicates an acceptable alternative. If so the first apparatus 10 will replace the unacceptable function with its acceptable alternative.

Although the invention has been set forth with respect to a specific embodiment, it will be clear that invention is not limited to this embodiment. For example, communication between the first apparatus 10 and the server 18 may also take place via a further apparatus (not shown) connected to the remote communication network 16. Although the system has been described in terms of a bus system and a computer program that is uploaded when the second apparatus is connected to the bus system, the principle of an acceptance server can also be used in other circumstances, such as when a new program (or a new version of such a program) is to be loaded into the first apparatus from some computer readable medium, such as a CD-ROM or via the Internet, without a second apparatus 12 being attached. However, it will be appreciated that the invention is especially advantageous in the case of a consumer bus system with various apparatuses, whose connection causes loading of a program or programs into other apparatuses. This is because such a system is generally arranged to mask from the consumer that making such a connection involves uploading of programs, let alone that it is made clear to the consumer that uploaded programs are not necessarily acceptable. (Masking is effected by automating the upload, so that the apparatus 12 triggers uploading by connection of the apparatus 12, be it by physical connection or switching on its power, and executing the upload without instructions from the user).

Moreover, consumer network systems, such as home bus systems connecting various consumer devices like TV's, video recorders and household appliances, tend to contain apparatuses with non-standardized functions executed by non-standardized programs from disparate manufacturers. As a result, the interoperability of such programs generally needs to be evaluated for the configuration (nature of available apparatuses, versions of software) in which these programs are executed, rather than merely by checking for a most recent version number.

As shown in the embodiment, the first apparatus 10 reports its configuration to the server 18. If the server 18 is provided by the manufacturer (or seller) of the first apparatus 10, the server 18 will only give information for first apparatuses of a specific manufacturer, so that information about the type of first apparatus 10 is already implicit in the address used by the first apparatus 10 to reach the server 18.

Such a server 18 provided by a manufacturer or seller of an apparatus can provide a post-sale customer service that considerably increases the value of the first apparatus 10 for the customer. Alternatively, the server may be provided as a general service (for a subscription fee or a per case fee) for apparatuses from different manufacturers.

1. A method of protecting the integrity of a computer system, the method comprising
loading a new system component into a system with a computer;
in response to said loading, sending information about said system component and a configuration of the system with a to an acceptance server via a remote communication network;
verifying with said acceptance server whether the system with a computer including the system component and configured according to information about the configuration meets a criterion of interoperability;
sending an acceptance signal from the acceptance server to the system with a computer via the remote communication network;
qualifying operation of the system with a computer including the system component dependent on the acceptance signal.

2. A method according to claim 1, comprising
sending information that determines a computer program for controlling a controllable apparatus from the controllable apparatus to the system with a computer, when the controllable apparatus is coupled to the system with a computer via a local communication network;
said system component being the computer program, the acceptance server being directed at verifying whether the computer program will execute in the configuration according to the criterion of interoperability;
control of an operation of the controllable apparatus by the system with a computer with the computer program being qualified according to the acceptance signal.

3. A system with a computer, the system comprising
means for introducing a new system component into the system;
an acceptance server;
a remote communication network;
an apparatus coupled to the acceptance server via the remote communication network, the apparatus being arranged to send information about said system component and a configuration of the system with a computer to the acceptance server via the remote communication network, in response to said loading;
said acceptance server being arranged to verify whether the system with a computer including the system component and configured according to information about the configuration meets a criterion of interoperability and to send an acceptance signal to the system with a computer via the remote communication network;
the apparatus being arranged to qualify operation of the system with a computer including the system component dependent on the acceptance signal.

4. An apparatus for use in a system with a computer, comprising
the computer;
an input for receiving a computer program for execution by the computer;
an communication interface for communication to a remote acceptance server, the apparatus being arranged to send information about the computer program and a configuration of apparatus to the acceptance server and to receive an acceptance server in return to said information, the apparatus being arranged to qualify execution of the computer program by the computer according to the acceptance signal.

5. An apparatus according to claim 4 comprising a connection for connection to a controllable apparatus, the connection comprising said input for receiving the computer program, the computer program being a program for controlling the controllable apparatus via the connection, the apparatus qualifying control of the controllable apparatus according to the acceptance signal.

6. An apparatus according to claim 4, the information about the configuration identifying the type of an apparatus, said criterion including a sub-criterion for the compatibility of the apparatus, as identified by the information about the configuration, and the computer program.

7. An apparatus according to claim 4, the computer program being arranged to execute selectable ones of a plurality of functions, the acceptance signal comprising an identification of the acceptability of respective ones of the functions, said qualifying being selective for the respective functions.

8. An apparatus according to claim 4, wherein said qualifying comprises disabling execution of a part or whole of computer program, as far as identified as unacceptable by the acceptance signal.

9. An apparatus according to claim 4, wherein said qualifying comprises generating a warning signal to a user about the computer program or parts thereof when a user attempts to cause operation of computer program or the parts thereof and/or generating the warning signal upon any first user action after reception of the acceptance signal.

10. An apparatus according to claim 4, the apparatus being arranged to execute enable unqualified execution at least part of the computer program until the apparatus has received the acceptance signal received from the acceptance server.

11. A method of providing support for a system with a computer, the method comprising
providing an acceptance server coupled to a communication network;
receiving information with the server about a configuration of the system with a computer and a new system component of that system with a computer via the communication network;
checking with the server whether the system component and configured according to information about the configuration meets a criterion of interoperability;
sending an acceptance signal back from the server to a source of said information, the acceptance signal signaling whether said criterion of interoperability is met.

12. A method according to claim 11, wherein the server is selectively reachable through the communication network using a network address, the network address being specific to a predetermined type of apparatus, or family of types of apparatuses, the criterion being specialized to said family.

13. A method according to claim 11, wherein the new component is a computer program, the information comprising at least part of a code of said computer program, the method comprising analyzing the executable code with the server to determine whether its effect meets the criterion when executed by the system with a computer.

14. A method according to claim 13, wherein the computer program is arranged to handle selectable ones of a set of events, the server determining handling which of the events meets said criterion, the acceptance signal particularizing which of the events are acceptable.
